(19) United States
(12) Patent Application Publication
(10) Pub. No.: US 2009/0162620 A1
(43) Pub. Date: Jun. 25, 2009

(54) Rotomolding labels

(75) Inventors: John William Swabey, Calgary (CA); Marek Jon Crawford, Calgary (CA); Kathleen Elizabeth McCormick, Calgary (CA)

Correspondence Address: Kenneth H. Johnson;Pantent Attorney, P.O. Box 630708, Houston, TX, 77263, US

(73) Assignee: NOVA Chemicals (International) S.A.

(21) Appl. No.: 12/313,314

(22) Filed: Nov. 19, 2008

(30) Foreign Application Priority Data
Dec. 20, 2007 (CA) 2,615,640

(51) Int. Cl. B32B 3/10; B32B 5/00; B05D 3/00; B29C 41/46

(52) U.S. Cl. 428/195.1; 428/220; 427/331; 264/331.11

(57) ABSTRACT

In-mold rotomolding labels comprise a printed sheet and a “cover stock” layer that covers the printed sheet and also provides adhesion of the label to the mold prior to the rotomolding procedure. The cover stock is prepared from a high melting polyethylene and a low melting polyolefin and is characterized by having a non-homogeneous morphology in which discrete “islands” of the polyethylene are present in a continuous “sea” of the polyolefin. The cover stock melts during the rotomolding process to provide a protective cover for the label graphics.

### FIELD OF THE INVENTION

This invention relates to in-mold labels for plastic parts, especially parts that are prepared by rotational molding (or “rotomolding”). The inventive labels are prepared with a novel cover stock that is applied to the mold surface prior to the rotomolding process.

### BACKGROUND OF THE INVENTION

Labels, decals and graphics are often applied to the surface of a molded polyolefin article. Labels that are applied to a mold surface prior to the molding process are commonly called in-mold labels. Labels for blow molding are often referred to by those skilled in the art as IML-B, for injection molding as IML-I and for rotational molding as IML-R.

U.S. Pat. No. 5,498,307 (Stevenson) discloses the use of micronized polyethylene and vegetable oil as an adhesive paste for a label in a rotomolding process.

U.S. Pat. No. 5,840,142 (Stevenson et al.) discloses the use of indicia of finely divided polyolefin, wax and pigment with a coating of 1 to 99 percent polyolefins and a binder selected from rosins, hydrocarbon resins and waxes and terpene resins.

U.S. Pat. No. 6,815,005 (Stevenson et al.) discloses the use of thermoplastic powder, binder solid and colorant in a liquid carrier to produce decorative enhancements to polyethylene surface.

U.S. Pat. No. 7,128,970 (Stevenson) discloses a pressure sensitive adhesive with a transition temperature comparable to the demolding temperature in a rotational molding process.

WO 06/053267 (Blackwell et al.) describes in mold labels prepared from a melt blend of polyolefins.

U.S. Pat. No. RE37,248 (Dudley) discloses a polymeric adhesive label with a heat activated adhesive substrate for blow molding made of ethylene polymer/copolymer.

### SUMMARY OF THE INVENTION

In one embodiment, the present invention provides a cover stock for in-mold labels, where the cover stock is a two-phase polymer layer having a thickness of from 0.5 to 20 mils, said layer comprising:
I) from 60 to 90 weight % of a polyethylene A having a peak melting point of greater than 90° C., wherein said polyethylene A is provided as particles having an average particle size of from 1 to 400 microns; and
II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B.

This cover stock may be formed into an in-mold label by, for example, laminating the cover stock on top of a printed sheet. Thus, in another embodiment, the present invention provides a label for a rotomolded part, said label comprising:
1) a graphics film containing an image; and
2) a cover stock comprising a two-phase polymer layer having a thickness of from 0.5 to 20 mils, said layer comprising:
   I) from 60 to 90 weight % of a polyethylene A having a peak melting point of greater than 90° C., wherein said polyethylene A is provided as particles having an average particle size of from 1 to 400 microns; and
   II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B.

The above-described label is especially suitable for the preparation of an in-mold label for a rotomolded part. Thus, in another embodiment, the present invention provides a process to form a rotomolded part having a molded-in-label, said process comprising:
A) placing in a mold a label for a rotomolded part, said label comprising:
   1) a graphics film containing an image; and
   2) a cover stock comprising a two-phase polymer layer having a thickness of from 0.5 to 20 mils, said layer comprising:
      I) from 60 to 90 weight % of a polyethylene A having a peak melting point of greater than 90° C., wherein said polyethylene A is provided as particles having an average particle size of from 1 to 400 microns; and
      II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B,
         wherein said cover stock is applied to a surface of said mold;
B) filling said mold with rotomoldable plastic; and
C) heating and rotomolding said rotomoldable plastic.

The above-described (non-homogeneous) morphology of the cover stock is an essential element of the present invention. The morphology may be obtained by a thermal mixing process which is conducted at a temperature that is high enough to melt polyolefin B but not polyolefin A (hence the requirement for the different melting points, as specified above) —then cooling the melt so as to leave “islands” of component A in a “sea” of component B. An alternative method to produce this morphology is to 1) mix polyolefin A and polyolefin B in a liquid which is a solvent for polyolefin B but a non-solvent for polyolefin A; then 2) deposit the “solvent-slurry” on a surface; and 3) drive off the liquid to leave a thin film of the non-homogeneous polymer blend (and this method is described in more detail in the examples).

Another essential element of the present invention is the particle size of polyolefin A, which must be less than 400 microns. More particularly, the average particle size is from 1 to 400 microns (preferably from 1 to 200 microns). Particle size is measured by ASTM D-1921. (For particle sizes less than about 50 microns, it may be preferable to use a light scattering technique to measure particle size, as disclosed in ISO 13320). Particle sizes greater than 400 microns are to be avoided because they may leave “chunks” or lumps” in the cover stock film.

### DETAILED DESCRIPTION OF PREFERRED EMBODIMENTS

As used herein, the term “cover stock” is used to describe the above defined “two-phase layer” of polyethylene A and polyolefin B having the specified morphology. The cover stock is generally provided as a film having a thickness of from 0.5 to 20 mils (preferably from 0.5 to 10 mils).

Polyethylene A has a peak melting point as determined by Differential Scanning Calometry (or “DSC”) of greater than 90° C. using the DSC test method of ASTM D3418. For clarity, if polyethylene A has two or more melting points, the maximum melting point is greater than 90° C.

Suitable examples of polyethylene A include “heterogeneous” copolymers of ethylene and an alpha olefin such as butene, hexene or octene (where the term “heterogeneous” means that the copolymer has more than one melting peak as determined by DSC); high density polyethylene having a density of greater than 0.950 grams/cubic centimeter (“g/cc”, as determined by ASTM D1505) and a melt index, (as determined by ASTM 1238; conditions of 190° C. and 2.16 kg weight, “I₂”) of less than 100 grams/10 minutes (preferably from 0.1 to 30 grams/15 minutes); high pressure, low density polyethylene which is produced with a free radical initiator having a melt index, 12, of less than 100 grams/10 minutes (preferably from 0.1 to 30 grams/10 minutes).

It is preferred that polyethylene A contains little or no comonomer. It is especially preferred that polyethylene A comprises at least 99 mole % ethylene. For clarity, this means that preferred polyethylene A contains at least 99 mole % of polymer units obtained from ethylene and less than or equal to 1 mole % of polymer units obtained from optional comonomer.

It is essential that the starting particle size of polyethylene A be from 1 to 400 microns (preferably from 1 to 200 microns), where the term “starting” refers to the particle size before blending with polyolefin B.

Polyolefin B has a melting point as determined by DSC of less than 70° C. Examples of suitable materials for polyolefin B include very low-density polyethylene ( a copolymer of ethylene and at least one C₄ to C₈ alpha olefin such as butene, hexene or octene) having a density of less than 0.900 g/cc (especially less than 0.885 g/cc); ethylene—vinyl acetate; and atatactic polypropylene. Very low-density polyethylene (“VLDPE”) is especially preferred. Highly preferred VLDPE has a melt index, I₂, of from 1 to 500 g/10 minutes and a modulus (as determined by ASTM D638 at 508 mm/minute) of from 0.1 to 10 MPa, especially 0.1 to 5 MPa.

The cover stock is prepared by blending from 60 to 90 weight % of polyethylene A (preferably from 70 to 80%) and from 40 to 10 weight % of polyolefin B (preferably from 30 to 20%). The cover stock is generally provided in the form of a film having a thickness of from 0.5 to 20 mils.

Preparation of Labels from Cover stock

The cover stock of this invention serves two purposes:
1) it covers and protects the graphics of the in-mold label; and
2) it serves to adhere the label to the mold surface prior to molding operations.

The graphics for the label are provided by way of a “graphics film”. In the simplest (and most preferred) form, the graphics film is a printed sheet. The sheet is made from a material that is resistant to and compatible with the molding process. Examples of suitable materials include paper, synthetic papers (such as the synthetic papers sold under the trademarks TESLIN by PPG Industries and ARTISAN by Daronmic LLC) and polymer films, especially a polyolefin film such as a polyethylene film.

The use of synthetic papers such as Teslin® is preferred because they may be printed with a wide variety of inexpensive printers, as described in the examples.

A label according to this invention may be prepared by simply covering the “graphics sheet” with the “cover stock”. In a preferred embodiment, a lamination layer is included between the graphics sheet and cover stock. The lamination layer serves to provide additional protection to the graphics and to improve the overall robustness of the label. The lamination layer is preferably from 0.5 to 10 (especially 1 to 5) mils thick and is preferably an inexpensive polymer film, especially a polyethylene or polypropylene film.

The lamination layer may also contain additives to improve the longer-term durability of the film, including: ultraviolet (“UV”) blockers such as titanium oxide; UV absorbers; hindered amine light stabilizers (HALS); hindered phenols and phosphides. These additives may also be added to the polymers used to prepare the cover stock if the lamination layer is not included.

The layers of the finished film are preferably heat laminated together (at a temperature lower than the melting point of polyethylene A, so as to preserve the non-homogeneous morphology of the cover stock). (It will also be recognized by those skilled in the art that lamination temperatures above the melting point of polyethylene A may be used for very short time intervals while still maintaining the non-homogeneous morphology—provided that the total amount of enthalpy provided to the lamination process is not sufficient to fully melt the polyethylene A). Suitable techniques for heat lamination are described in the examples. As an alternative, the layers may be laminated together with an adhesive.

The label is then ready for use in a rotomolding process. The label is applied to an empty mold such that the cover stock of the label is against the mold surface. The mold is preferably warm (30-70° C.) for safe and easy application of the label. Alternatively, the label may be applied at an even higher temperature in order to improve molding efficiencies (by reducing the amount of time required to reheat the mold).

In order to ensure that the label adheres to the mold, the mold temperature should be above the temperature at which polyolefin B starts to become tacky (in general, above 30° C.). The use of a burnishing tool (such as a rubber roller) helps to ensure that the label is applied smoothly. Under these conditions, labels that are made with VLDPE (as the preferred polyolefin B) will typically be held firmly in place by the tackiness of the label against the main mold. However, in general, the label may also be peeled off and repositioned (prior to molding) if desired. The mold is then charged with a rotomoldable plastic (preferably polyethylene) and a rotomolded part is then prepared using any conventional rotomolding technique. The heat from the rotomolding process melts the polyethylene A material. Upon cooling, polyethylene A becomes non-tacky and thus allows the cover stock to easily release from the mold.

Further details are provided in the following non-limiting examples.

### EXAMPLES

### Part I: Preparation of Cover Stock

### Example 1

### Compression Molded Cover Stock

This example illustrates the preparation of a two phase polymer layer (“cover stock”) by compression molding a mixture of polyethylene A and polyolefin B at a temperature above the melting point of polyolefin B but below the melting point of polyethylene A.

The compression molding was completed in a conventional press mold (sold under the trademark WABASH) equipped with two steel plates. The plates were coated with polytetrafluoroethylene (“TEFLON”) film to facilitate release of the cover stock from the plates.

Polyethylene A was purchased from Equistar with the following
reported properties:
I₂: 10 grams/minute
Density: 0.952 g/cc
Peak melting point (m.p.): 134° C.
Average particle size: 20 microns

Polyolefin B was a VLDPE purchased from Dow Chemical with the following reported properties:
I₂: 5 g/10 minutes
Density: 0.870 g/cc
Peak m.p.: 59° C.
100% modulus: 2.3 MPa

A blend of 70 weight % polyethylene and 30 weight % polyolefin B was mixed at 100% in a small mix head blender, then compression molded at 100° C. to a thickness of less than 10 mils to prepare “cover stock CO-1”.

“Cover stock CO-2” was prepared as above except polyolefin B was replaced with polyolefin B^{I} using the following properties:
I₂: 5 g/10 minutes
Density: 0.865 g/cc
Peak m.p.: 35° C.
100% modulus: 2.3 MPa

### Example 2

### Cover Stock from a “Solution-Slurry”

This example illustrates the preparation of a cover stock according to the present invention by the deposition of a solution-slurry of polyethylene A and polyolefin B. The term “solution-slurry” is meant to indicate that one of the polymers (polyolefin B) is in solution while the other is not fully dissolved.

The “solution-slurry” was prepared by mixing 31.5 weight % of polyethylene A (as described in Example 1), 13.5 weight % of polyolefin B (as per Example 1) and 55 weight % of decane (which is a solvent for polyolefin B but not polyethylene A) at 70° C. in an agitated vessel.

The solution-slurry was coated from a slot die (having a width of about 9 inches or about 23 cm) on to a film made from biaxially orientated polypropylene (“BOPP”) at a thickness to provide a polymer coating of about 2 mils. The so coated BOPP was then dried by passing it through a continuous oven with an internal temperature of about 100° C. The cover stock film (with a peelable BOPP liner) was wound on to a cardboard core to provide a roll of the cover stock. This cover stock is referred to hereinafter in cover stock “S-1”.

It is important to note that the internal oven temperature (100° C.) is below the peak melting point of polyethylene A (134° C.). The resulting cover stock film had a non-homogeneous morphology, with discontinuous, discrete particles of polyethylene A being dispersed in a continuous phase of polyolefin B. This morphology was confirmed using Atomic Force Microscopy (“AFM”), which showed discrete “islands” of polyethylene A dispersed in a continuous “sea” of polyolefin B. For clarity, these “islands” were visible (using AFM) as discrete particles having a particle size of less than 100 microns.

Additional cover stocks were made according to the solution-slurry procedure as generally described except that different “polyolefin B” materials were used as indicated below:
Cover stock “S-2”: Polyolefin B^{I} was a VLDPE having the following properties:
I₂: 5 g/10 minutes
Density: 0.865 g/cc
Peak m.p.: 35° C.
100% modulus: 2.3 MPa
Cover stock S-3 7447-2A was made with 20 weight % polyolefin B^{I} (80 weight % polyethylene A).
Cover stock S-4 was made with 25 weight % polyolefin B^{I} (75 weight % polyethylene A).
Cover stock S-5 was prepared with 30 weight % polyolefin B^{I} (70 weight % polyethylene A).

Further cover stocks were prepared with Polyolefin B^{II} (a VLDPE with the following properties):
I₂: 1 g/10 minutes
Density: 0.857 g/cc
Peak m. p. 38° C.
100% modulus: 2.3 MPa
Cover stock S-6:20/80 (weight % polyolefin B^{II}/polyethylene A).
Cover stock S-7:25/75 (weight % polyolefin B^{II}/polyolefin A).
Cover stock S-8:30/70 (weight % polyolefin B^{II}/polyolefin A).

### Part II: Graphics Films

Different “Graphics films” were prepared as follows:
Graphics Film 1: Synthetic paper (sold under the trademark Teslin SP-800) was printed using an ink-jet printer sold under the trade name Mutoh-Falcon II. This type of synthetic paper is opaque, so the printed graphics are only clearly visible from one side (referred to herein as the “top side” of the graphics film).
Graphics Film 2: This film was prepared by printing an image on Teslin SP-800 synthetic paper with an ink-jet printer sold under the trademark HP DeskJet D4100 (using conventional ink).
Graphics film 3: This film was prepared by printing a synthetic paper sold under the trademark “ARTISYN” with the HP DeskJet D4100 printer.
Graphics film 4: This film was prepared by printing a synthetic paper sold under the trademark “IGAGE” (water proof) with the HP DeskJet D4100 printer.
Graphics Film 5: This film was prepared by:
a) corona treatment of a 3 mil thick polyethylene film (of the same type described for use as the “lamination layer” in Part III, below); and
b) coating the corona-treated film with a pattern made from blue and white inks by Color Conventions Industries (trademark SEALTECH ink).

### Part III: Preparation of Labels

Two and three layer films according to this invention were prepared according to the following general procedures.

Simple two layer films were prepared by laminating the cover stock directly to the graphics film (at a temperature lower than the melting point of polyethylene A).

Three layer films were prepared by laminating a “lamination” layer between the cover stock and graphics film. The lamination layer (when used) was prepared from a conventional low density polyethylene homopolymer (“LD”) having a melt index, I₂, of about 4.5 g/10 minutes and a density of about 0.917 g/cc, (sold under the trademark LD-0517-A by NOVA Chemicals Incorporated of Pittsburgh, Pa.).

### Two Layer Labels

Two layer labels were prepared by laminating cover stock (prepared in the manner described in Part I) directly to graphics film (prepared in the manner described in Part II) in a conventional heat seal lamination sold under the trademark “GBC Heat Seal H600 Pro”. Temperature settings between 100 and 115° C. were used. “Speed settings” on the lamination of 1 or 2 were used (corresponding to a sealing time estimated to be about one half second). Polyester sheets (sold under the trademark MYLAR) were placed on both sides of the label for the lamination process to facilitate release from the machine.

“Label 2-1”: was prepared by laminating a film of cover stock CO-1 (from Part I) over a layer of graphics film 2 (from Part II). The cover stock was placed on the “top side” (i.e. the printed side) of the graphics film.

### Three Layer Films

Three layer labels were made as generally described above (i.e. “GBC Heat Seal H600 Pro” lamination; temperature: 100-115° C.; speed settings: 1 or 2; “MYLAR film”) with the exception that a “lamination layer” was included between the cover stock and graphics film. In all cases, the lamination layer was the LD film (described above) having a thickness of about 2 mils. Three layer labels were prepared with the following structures:
graphics film (or “GF”)/lamination layer or (“LL”)/cover stock or (“CS”):
Label 3-1: GF1/LL/CO-1
Label 3-2: GF1/LL/CO-2
Label 3-3: GF1/LL/S-1
Label 3-4: GF1/LL/S-6
Label 3-5: GF1/LL/S-7
Label 3-6: GF1/LL/S-8
Label 3-7: GF3/LL/S-1
Label 3-8: GF4/LL/CO-1
Label 3-9: GF5/LL/S-1

In all cases, the lamination layer, LL, was placed on the “top side” of the graphics film.

### Part IV: Rotational Molding

Rotomolded polyethylene cubes having an in-mold label were prepared using an aluminum mold and a commercial rotomolding machine (sold under the trademark Ferry RS-160). The polyethylene used was a high density ethylene-octene copolymer resin having a melt index, I₂, of 5.2 g/10 minutes and a density of 0.937 g/cc. Each face of the cube was about 30 cm. The resin charge size was about 2 kg which provides a hollow molded cube having a wall thickness of about 0.13 inches (about 0.3 cm). The oven temperature was 520° F. and the oven time was about 15 minutes, followed by forced air cooling for about 23 minutes. A conventional mold release was applied to the mold surface. Parts were easily de-molded at a temperature above 60° C.

The labels used in the experiments were applied directly to the mold surface, with the “cover stock” layer of the label in contact with the mold surface. A layer of wax was often applied to the mold surface in the area where the label was applied, prior to placing the label in the mold. Paraffin wax was used at temperatures of 60° C. or higher and “alkene homopolymer wax” (trademark BYBAR, by Baker Petrolite) was used at temperatures of 40° C. and 50° C. Excess wax was wiped off the mold surface with a cloth prior to positioning the label.

Table 1 provides a summary of labels and molding conditions. All of the molded parts according to this example produced acceptable labels —with little or no adhesion of the cover stock to the mold surface and high quality images (i.e. clear label surfaces, without discoloration or blisters).

TABLE 1

| | | Mold Surface | Wax |
|---|---|---|---|
| Experiment | Label | Temperature | (Y or N) |
| 1 | 3-1 | 50 | Y |
| 2 | 3-3 | 60 | Y |
| 3 | 3-3 | 60 | N |
| 4 | 3-3 | 60 | Y |
| 5 | 3-3 | 70 | Y |
| 6 | 3-3 | 75 | Y |
| 7 | 3-3 | 100 | Y |
| 8 | 3-6 | 40 | Y |
| 9 | 3-7 | 40 | Y |
| 10 | 3-8 | 40 | Y |
| 11 | 2-1 | 60 | Y |
| 12 | 3-4 | 60 | Y |
| 13 | 3-5 | 60 | Y |
| 14 | 3-9 | 60 | Y |

### Comparative Example 1

A blend of 70% high density polyethylene (density 0.937 g/cc; melt index, I₂, 5.2 g/10 minutes; peak melting point greater than 100° C.) and 30% of the polyolefin B (a VLDPE, melt index, I₂, 5 g/10 minutes; density: 0.870 g/cc; melting point: 59° C.; 100% modulus: 2.3 MPa) was prepared at a temperature of above 200° C. The resulting blend was “homogeneous” due to the mixing temperature (i.e. it did not have the non-homogeneous morphology of the cover stock of this invention). A comparative cover stock was prepared by casting a film having a thickness of about 4 mils from this “homogeneous” blend. A comparative label was then prepared by laminating the comparative cover stock to graphics film 1 at 150° C. The resulting label did not adhere to the surface of the aluminum mold used in Part IV above (at 60° C., regardless of whether the mold surface was treated with wax of not).

### Comparative Example 2

A blend of 30 weight % high density polyethylene (as per Comparative Example 1) and 70 weight % polyolefin B (also as per Comparative Example 1) was melt blended at 150° C. The resulting “homogeneous” blend was used to make a comparative cover stock by casting a 4 mil film. The comparative cover stock was laminated to graphics film 1 at a lamination temperature of 150° C. This comparative film adhered well to a 60° C. aluminum mold. However, after rotomolding a polyethylene cube (in the manner described in Part IV above), this comparative cover stock became stuck to the mold. Thus, in general, the “homogeneous” cover stock of Comparative Example 1 did not adhere to the mold and the homogeneous cover stock of this Comparative Example was stuck to the mold.

### Comparative Example 3

An attempt was made to apply a layer of the “lamination layer” film (LD film, 2 mils thick, described in Part III above) to the aluminum mold at a temperature of 60° C. This film would not adhere to the mold surface (regardless of whether the surface was treated with wax or not).

### Comparative Example 4

A hydrocarbon grease (sold under the trademark Apiezon H) was applied to the aluminum mold surface. A “lamination layer” film (LD film, 2 mils thick) was held in place by this grease. A rotomolded PE cube was then prepared as generally described in Part IV above. The grease discolored during the molding operation and produced an undesirable brown stain on the molded part.

### Comparative Example 5

Comparative Example 4 was repeated using a silicone grease (trademark Dow Corning III) instead of the hydrocarbon grease. The resulting rotomolded part de-molded well and was not stained. However, the silicone grease left an undesirable residue on the molded part.

### Comparative Example 6

A mixture of 25 weight % of the polyethylene used to prepare the “lamination layer” (of Part III) and 75 weight % canola oil was heated to 130° C. (above the melting point of the polyethylene). This produced a clear solution. Upon cooling, the polyethylene precipitated out of solution to form a viscous suspension. This viscous suspension was applied to the aluminum mold surface. Attempts to adhere a “lamination layer” to the so treated surface were not successful.

What is claimed is:

1. A two-phase polymer layer having a thickness of from 0.5 to 20 mils, said layer comprising:
I) from 60 to 90 weight % of a polyethylene A having a peak melting point of greater than 90° C., wherein said polyethylene A is provided as particles having an average particle size of from 1 to 400 microns; and
II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B.

2. The two-phase layer of claim 1, wherein said polyolefin B is a copolymer of ethylene and at least one C₃ to C₈ alpha olefin; and wherein said copolymer has a density of less than 0.885 grams per cubic centimeter.

3. The two-phase layer of claim 1, wherein said polyolefin B has a melt index, I₂, of from 1 to 500 grams/10 minutes and a modulus of 0.1 to 5 MPa.

4. The two-phase layer of claim 1, wherein said polyethylene A has a melt index, I₂, of from 0.5 to 50 grams/10 minutes.

5. The two-phase layer of claim 1, wherein said polyethylene A comprises at least 99 mole % ethylene and has a melt index, I₂, of from 0.1 to 30 grams/10 minutes.

6. The two-phase layer of claim 1, wherein said thickness is from 0.5 to 10 mils and said polyethylene A has an average particle size of from 1 to 200 microns.

7. The two-phase layer of claim 1, wherein said polyethylene A has a density of greater than 0.950 g/cc.

8. A label for a rotomolded part, said label comprising:
1) a graphics film containing an image; and
2) a cover stock comprising a two-phase polymer layer having a thickness of from 0.5 to 20 mils, said layer comprising:
I) from 60 to 90 weight % of a polyethylene A having a peak melting point of greater than 90° C., wherein said polyethylene A is provided as particles having an average particle size of from 1 to 400 microns; and
II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B.

9. The label of claim 8, wherein said film containing an image is a printed sheet.

10. The label of claim 8, wherein said label further comprises a lamination layer that is located between said film and said cover stock.

11. The label of claim 8, wherein said cover stock has a thickness of from 1 to 5 mils.

12. The label of claim 8, wherein said lamination layer has a thickness of from 1 to 5 mils.

13. The label of claim 9 wherein said sheet is opaque.

14. A process to make a two-phase polymer layer having a thickness of from 0.5 to 20 mils, said layer comprising:
I) from 60 to 90 weight % of a polyethylene A having a peak melting point of greater than 90° C., wherein said polyethylene A is provided as particles having an average particle size of from 1 to 400 microns; and
II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B, said process comprising:
I) forming a two-phase solvent-slurry by mixing said polyethylene A and said polyolefin B in a liquid which is a solvent for said polyolefin B and which is a non-solvent for said polyethylene A;
II) depositing said solvent-slurry as a thin coating on a non-stick surface; and
III) removing said liquid so as to form a two-phase polymer layer having a thickness of from 0.5 to 20 mils.

15. The process of claim 13, wherein said non-stick surface provides a peelable backing.

16. A process to form a rotomolded part having a molded-in-label, said process comprising:
A) placing in a mold a label for a rotomolded part, said label comprising:
1) a graphics film containing an image; and
2) a cover stock comprising a two-phase polymer layer having a thickness of from 0.5 to 20 mils, said layer comprising:
I) from 60 to 90 weight % of a polyethylene A having a peak melting point of greater than 90° C., wherein said polyethylene A is provided as particles having an average particle size of from 1 to 400 microns; and
II) from 40 to 10 weight % of a polyolefin B having a peak melting point of less than 70° C., wherein said two-phase layer is characterized by having a morphology wherein said polyethylene A forms a discontinuous phase of discrete particles in a continuous phase of said polyolefin B.
B) filling said mold with rotomoldable plastic; and
C) heating and rotomolding said rotomoldable plastic.
